(19) United States
(12) Patent Application Publication
(10) Pub. No.: US 2008/0282171 A1
(43) Pub. Date: Nov. 13, 2008

(54) System and method for production of online magazines

(75) Inventors: Arnon Katz, London (GB); Nicolas Bussard, Montpellier (FR)

Correspondence Address: MARTIN D. MOYNIHAN d/b/a PRTSI, INC., P.O. BOX 16446, ARLINGTON, VA, 22215, US

(73) Assignee: Coldbrook Business Corp., Geneva (CH)

(21) Appl. No.: 11/797,732

(22) Filed: May 7, 2007

(51) Int. Cl. G06F 17/30

(52) U.S. Cl. 715/735

(57) ABSTRACT

A computer system for supporting inclusion of continuously updated content into web publications, the computer system including an input unit for obtaining content from a plurality of sources of continuously updatable content at independent locations over a network, and a selection unit for representing the plurality of sources to a user, allowing the user to select from the plurality of sources using the selection unit, thereby building content from the selected sources into a web publication produced online by the user. Related apparatus and methods are also described.

### FIELD OF THE INVENTION

The present invention relates to a system and method for production of online magazines (Zlogs) and, more particularly but not exclusively, to a system and method for production of online magazines with automatically-updated content.

### BACKGROUND OF THE INVENTION

Production of web sites, web logs (blogs), online magazines, and other such publicly available web sites on the World Wide Web (WWW) is traditionally done by HTML programmers and web designers. The tools used by the HTML programmers and web designers resemble programmers' tools, and are somewhat daunting to many WWW users.

Some tools are available which enable production of a web site without requiring the web site producer to possess programming proficiency.

By way of example, www.homestead.com provides tools for building a web site using prepared templates for many typical web site designs, and editing and adding functionality to the basic templates. Editing the prepared templates includes editing and adding text, images, web site navigation links, guest-books, user polls, and more. The www.homestead.com web site production tools enable making basic changes to the web site online, using a web browser to communicate with the www.homestead.com web site.

In order to produce a web site with advanced features, such as interactive forms, guest-books, user polls, and so on, the web site producer is required to download software from the www.homestead.com web site onto the web site producer's computer.

One desirable feature to be included in a web site, especially a web site possessing an online magazine (Zlog) format, is automatically-updated content, the content to be automatically-updated substantially frequently. One technology for enabling such automatically-updated content is called RSS technology. RSS is variously named Really Simple Syndication, or Rich Site Summary, or RDF Site Summary. Subscribers subscribe to a web site which provides an RSS feed, using an RSS-client-enabled browser, and view automatically-updated content on their browsers.

By way of another example, www.google.com allows a user to produce a personalized home page online, using a browser. The personalized home page is comprised of portions of web pages, each portion linked to, and providing content from, a different web site, each of which comprises a different content source. Some of the web sites update their content on a regular basis, such as once a day. Some of the web sites even use RSS technology. The personalized home page produced with the www.google.com tools is viewable by the user, but the user's personalized home page is not published, and not viewable by other users, as a public web site.

As can be understood from the above description, online web site design using simple tools is presently limited to a simpler design than is possible with offline tools.

There is thus a widely recognized need for, and it would be highly advantageous to have, an online magazine production tool devoid of the above limitations.

### SUMMARY OF THE INVENTION

According to one aspect of the present invention there is provided a computer system for supporting inclusion of continuously updated content into web publications, the computer system including an input unit for obtaining content from a plurality of sources of continuously updatable content at independent locations over a network, and a selection unit for representing the plurality of sources to a user, allowing the user to select from the plurality of sources using the selection unit, thereby building content from the selected sources into a web publication produced online by the user.

According to another aspect of the present invention there is provided a computer system for producing an automatically-updating online magazine, the online magazine including at least one World Wide Web (web) page, the computer system providing an online user with an interface for naming the online magazine, designing a layout of the online magazine, the designing a layout including producing at least one layout, the producing at least one layout including selecting at least one layout template from a list of layout templates, selecting at least one module from a list of modules, the module to be included in the at least one produced layout, and naming the at least one layout, thereby producing the at least one layout, producing at least one web page, the producing at least one web page including selecting at least one layout from the at least one layout produced, and naming the at least one web page, thereby producing at least one web page, selecting a home page from the at least one web page, adding custom data to be associated with the online magazine, and publishing the online magazine, wherein the at least one module includes content aggregated substantially frequently from a plurality of content feeds and the publishing makes the online magazine available to users of the web.

According to yet another aspect of the present invention there is provided a World Wide Web (web) server, the web server operative to communicate with users via the web, the web server operative to produce a web site including an online magazine, the online magazine including a name associated with the online magazine, a layout including at least one web page, produced by selecting at least one template from a list of web page templates, at least one module to be included in the at least one web page, the at least one module selected from a list of modules, the at least one module including content aggregated substantially frequently from a plurality of content feeds, and a name associated with the at least one web page, a home web page selected from the at least one web page, and custom data associated with the online magazine, and wherein the web server is operative to publish the web site including the online magazine, making the web site including the online magazine available to users of the web.

According to another aspect of the present invention there is provided a computer-readable storage medium containing a set of instructions for a general purpose computer having a user interface including a web browser on the World Wide Web (web), the set of instructions including (a) an input routine operatively associated with the user interface for producing an automatically-updating online magazine, the online magazine including at least one web page, the producing an automatically-updating online magazine including naming the online magazine, designing a layout of the online magazine, the designing a layout including producing at least one layout, the producing at least one layout including selecting at least one layout template from a list of layout templates, selecting at least one module from a list of modules, the module to be included in the at least one produced layout, and naming the at least one layout, thereby producing the at least one layout, producing at least one web page, the producing at least one web page including selecting at least one layout from the at least one layout produced, and naming the at least one web page, thereby producing at least one web page, selecting a home page from the at least one web page, adding custom data to be associated with the online magazine, and publishing the online magazine, wherein the at least one module includes content aggregated substantially frequently from a plurality of content feeds and the publishing makes the online magazine available to users of the web, and (b) a run routine for implementing the producing an automatically-updating online magazine.

According to yet another aspect of the present invention there is provided a computer-readable storage medium containing a set of instructions for a general purpose computer having a user interface including a web browser on the World Wide Web (web), the set of instructions including an input routine for obtaining content from a plurality of sources of continuously updatable content at independent locations over a network, a run routine for implementing the obtaining content from a plurality of sources, a selection routine for representing the plurality of sources to a user, allowing the user to select from the plurality of sources using the selection unit, thereby building content from the selected sources into a web publication produced online by the user, and a run routine for implementing the representing the plurality of sources to a user.

According to another aspect of the present invention there is provided a method for supporting inclusion of continuously updated content into web publications, the method including obtaining content from a plurality of sources of continuously updatable content at independent locations over a network, and representing the plurality of sources to a user, allowing the user to select from the plurality of sources, thereby building content from the selected sources into a web publication produced online by the user.

According to yet another aspect of the present invention there is provided an online method for producing an automatically-updating online magazine, the online magazine including at least one World Wide Web (web) page, the online method including naming the online magazine, designing a layout of the online magazine, the designing a layout including producing at least one layout, the producing at least one layout including selecting at least one layout template from a list of layout templates, selecting at least one module from a list of modules, the module to be included in the at least one produced layout, and naming the at least one layout, thereby producing the at least one layout, producing at least one web page, the producing at least one web page including selecting at least one layout from the at least one layout produced, and naming the at least one web page, thereby producing at least one web page, selecting a home page from the at least one web page, adding custom data to be associated with the online magazine, and publishing the online magazine, wherein the at least one module includes content aggregated substantially frequently from a plurality of content feeds and the publishing makes the online magazine available to users of the web.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified flow chart illustration of a preferred method of operation of a system constructed and operative in accordance with a preferred embodiment of the present invention;

FIG. 2 is a simplified illustration of an online magazine (Zlog) producer using a World Wide Web browser on a computer to interact with the system of FIG. 1 in order to produce an online magazine;

FIG. 3 is a simplified illustration of a user interface for producing a layout of the online magazine in accordance with the system of FIG. 1;

FIG. 4A is a simplified illustration of content sources associated with aggregation of content and automatic updating in accordance with the system of FIG. 1;

FIG. 4B is a simplified block diagram illustration of input, aggregation, automatic updating, and selection of content from content sources in accordance with the system of FIG. 1;

FIG. 5 is a simplified illustration of a user interface for producing a web page in accordance with the system of FIG. 1;

FIG. 6 is a simplified illustration of a user interface for adding custom data associated with the online magazine, saving, pre-viewing, and publishing the online magazine, in accordance with the system of FIG. 1; and

FIG. 7 is another simplified flow chart illustration of a preferred method of operation of the system of FIG. 1.

### DESCRIPTION OF PREFERRED EMBODIMENTS

The present embodiments comprise a system and a method for production of online magazines, also named herein Zlogs. The term “online magazine” is used throughout the present specification and claims interchangeably with the terms “Zlog” and “web publication”.

The present invention provides tools for online production of a Zlog comprising automatically-updated material, without requiring programming proficiency. More specifically, the Zlog production tools comprise a guided, step by step, process of selection of prepared templates and prepared modules from drop-down lists, and simple text entry.

The Zlog production system comprises a Zlog production server which communicates with Zlog producers via the World Wide Web (WWW). The Zlog producers use a standard WWW browser to connect and communicate with the Zlog production server.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

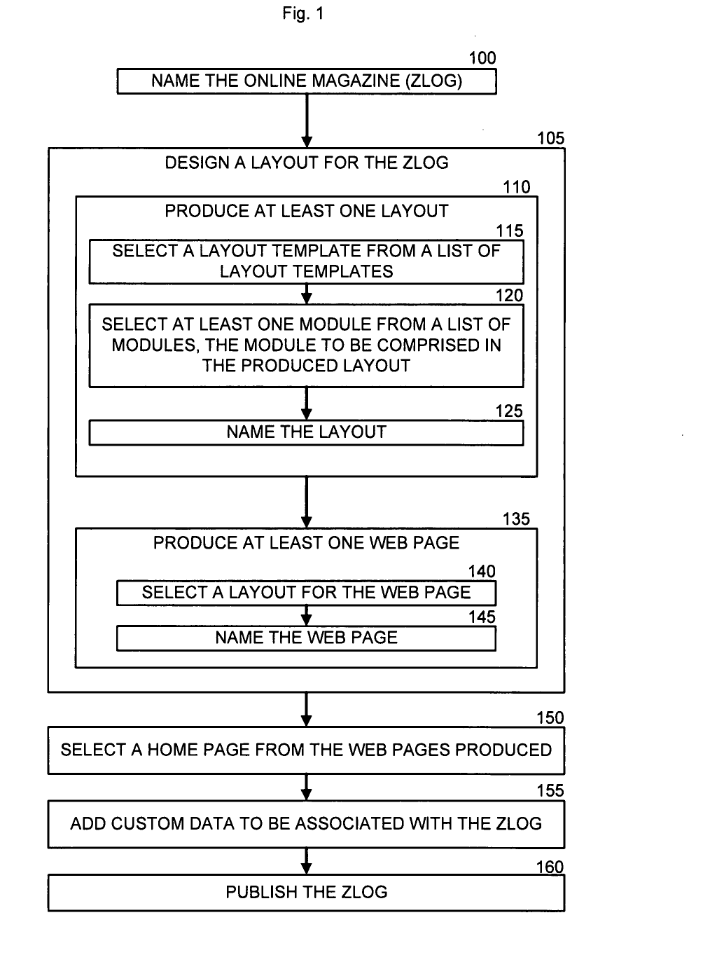

Reference is now made to FIG. 1, which is a simplified flow chart illustration of a preferred method of operation of a system constructed and operative in accordance with a preferred embodiment of the present invention.

A user of the WWW wishing to produce a Zlog using a preferred embodiment of the present invention, preferably initiates communication with the Zlog production server, via the WWW, as described above, and follows the steps described below. The user of the WWW, also termed herein the Zlog producer, is not shown in FIG. 1.

The Zlog producer first preferably names the Zlog (step 100).

Following the naming of the Zlog, the Zlog producer next designs a layout for the Zlog (step 105). Designing a layout preferably involves producing a layout (step 110), and producing a web page (step 135).

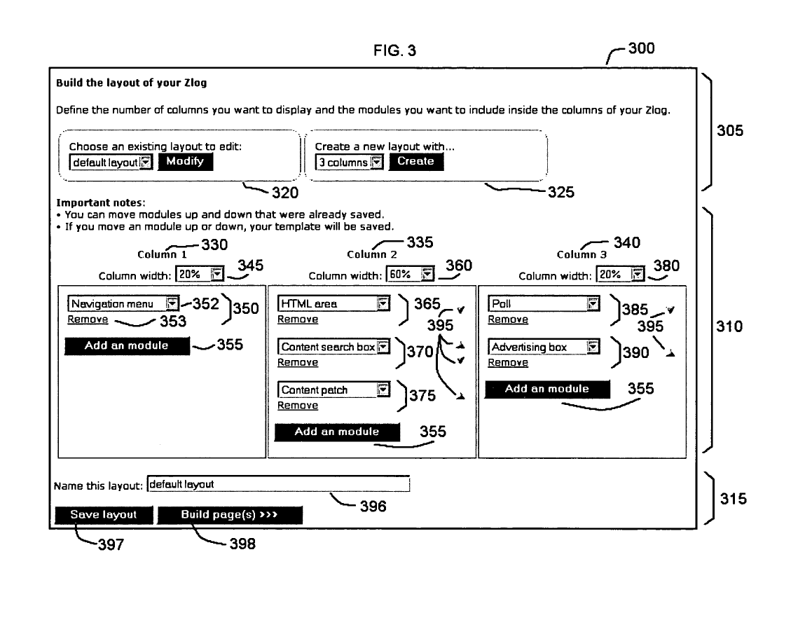

The Zlog producer produces the layout (step 110) by:
selecting a layout template from a list of layout templates (step 115);
selecting a module, from a list of modules, to be comprised in the layout (step 120). Modules are described in more detail below with reference to FIG. 3; and
naming the layout (step 125).

The Zlog producer may repeat producing the layout several times, thereby producing more than one layout, including different layouts for different portions of the Zlog.

Following the producing of the layout (step 110), the Zlog producer next produces the web page (step 135), by:
selecting a layout for the web page (step 140) from a choice of layouts. The choice of layouts comprises the layouts which the Zlog producer has produced on the Zlog server, and additional prepared layouts which the Zlog server makes available to all users of the system of FIG. 1; and
naming the web page (step 145).

It is appreciated that the Zlog producer may repeat producing the web page (step 135) several times, thereby producing more than one web page.

Persons skilled in the art will appreciate that web pages, and portions of web pages, are occasionally displayed in a tabbed format. The tabbed format is a method for navigating among more than one web page or portion of a web page. The tabbed format is considered throughout the present specification and claims to correspond to more than one web page or portion of a web page.

After producing as many web pages as the Zlog producer wished to include in the Zlog, the Zlog producer preferably selects a home page from the web pages produced (step 150).

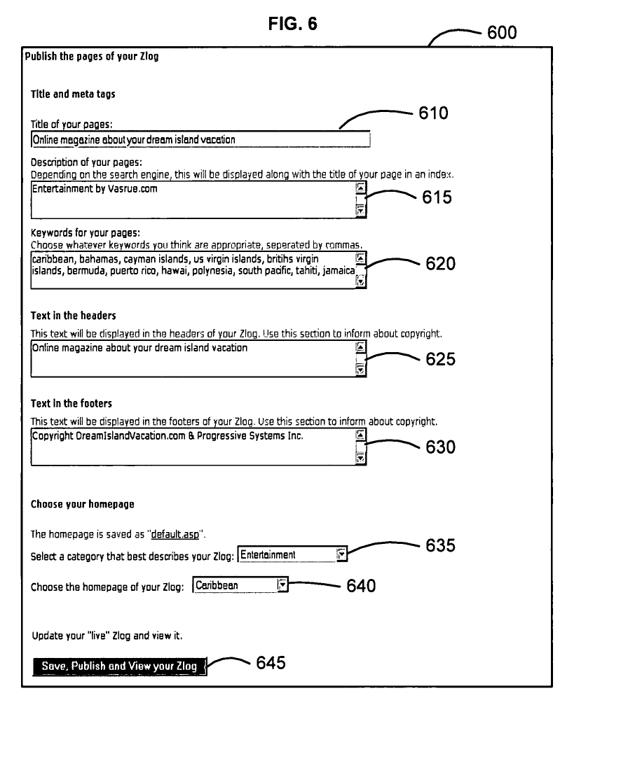

It is appreciated that the Zlog producer also preferably adds custom data to be associated with the Zlog (step 155). The custom data associated with the Zlog is described below with more detail with reference to FIG. 6.

Finally, the Zlog producer publishes the Zlog produced by the above method (step 160).

Persons skilled in the art will appreciate that steps may be added to the preferred method of operation of FIG. 1 without change in the substance of the method. By way of a non-limiting example, a step (not shown) may be added between step 100 and step 105, for selecting a style for the Zlog. If a style is selected for the Zlog, the style affects the look-and-feel of layouts and web pages produced in the Zlog.

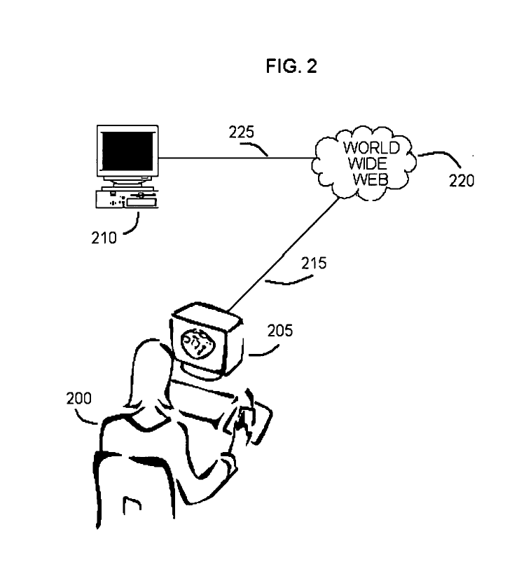

Reference is now made to FIG. 2, which is a simplified illustration of an online magazine (Zlog) producer 200 using a World Wide Web browser on a computer 205 to interact with the system of FIG. 1 in order to produce an online magazine. FIG. 2 depicts a typical situation in which the Zlog producer 200 wishes to produce an online magazine using a preferred embodiment of the present invention.

The Zlog producer 200 uses a computer 205 to interact with a Zlog production server 210 according to a preferred embodiment of the present invention. The computer 205 enables the Zlog producer 200 to interact with the Zlog production server 210 by the computer 205 having a connection 215 to the WWW 220, and the Zlog production server 210 also having a connection 225 to the WWW 220.

Persons skilled in the art will appreciate that interactions with online servers via the WWW 220 are well known in the art.

Reference is now made to FIG. 3, which is a simplified illustration of a user interface 300 for producing a layout of the online magazine in accordance with the system of FIG. 1. The user interface 300 of FIG. 3 is brought herein by way of a non-limiting example, in order to demonstrate a preferred functionality. It is to be understood that the phraseology and terminology employed in the user interface of FIG. 3 is for the purpose of description and should not be regarded as limiting.

The user interface 300 comprises three parts: a first part 305 for selecting a new layout; a second part 310 for designing the new layout; and a third part 315 for naming the new layout, saving the new layout, and initiating production of web pages.

The first part 305 of the user interface 300 comprises a first tool 320 for selecting a new layout from a selection of pre-existing layout templates, for possible later modification, and a second tool 325 for selecting a new layout from a selection of prepared blank layout templates.

The first tool 320 enables the Zlog producer 200 (FIG. 2) to select from a drop down list of prepared, named, layout templates which are provided in the system of FIG. 1. The prepared, named, layout templates provided in the system of FIG. 1 comprise layouts which the Zlog producer 200 (FIG. 2) has produced and saved on the Zlog production server 210 (FIG. 2), and other layout templates which the Zlog production server 210 (FIG. 2) makes available to all users of the system of FIG. 1.

The second tool 325 enables the Zlog producer 200 to select from a drop down list of prepared blank layout templates, which are named according to their geometric properties, such as, without limiting the generality of the foregoing, a 3-column layout template, a 2-column layout template, and so forth. The prepared blank layout templates are also layout templates which the Zlog production server 210 (FIG. 2) makes available to all users of the system of FIG. 1.

It is to be appreciated that the second part 310 of the user interface 300 and the third part 315 of the user interface 300 are displayed only after the Zlog producer 200 has made a selection using tools of the first part 305 of the user interface 300. The layout of the user interface 300 as it is depicted in FIG. 3 is at a stage of layout production when several modules have already been added to the new layout.

The second part 310 of the user interface 300 comprises tools for designing the new layout. The second part 310 displays a schematic interactive representation of the new layout produced by the Zlog producer 200, showing components comprised in the layout. By way of a non-limiting example, the new layout depicted in FIG. 3 was produced by selecting a prepared, blank, 3-column layout template, comprising a first column 330, a second column 335, and a third column 340.

The first column 330 comprises a tool 345 for changing the width of the first column 330 relative to a combined width of the first, second, and third columns; a module tool 350 comprising a navigation menu module, the navigation menu module being a prepared module supplied by the Zlog production server 210 (FIG. 2); and a button 355 for adding a module to the first column 330.

The module tool 350 comprising the navigation menu module comprises a drop down list 352, for replacing the navigation module, and a remove link 353, for altogether removing the navigation module from the first column 330. The drop down list allows the Zlog producer 200 to select a different prepared module to replace the navigation module. It is to be appreciated that other module tools 365, 370, 375, 385, 390 in the second part 310 of the user interface 300 also comprise drop down lists and remove links, with similar functionality as the drop down list 352 and the remove link 353.

The second column 335 comprises a tool 360 for changing the width of the second column 335 relative to the combined width of the first, second, and third columns; a module tool 365 comprising an HTML area module; a module tool 370 comprising a content search module; a module tool 375 comprising a content module; and a button 355 for adding a module to the second column 335.

The HTML area module, the content search module, and the content module are prepared modules supplied by the Zlog production server 210 (FIG. 2). The module tools 365, 370, 375 comprising the above-mentioned modules comprise drop down lists and remove links similar to the drop down list 352 and the remove link 353 described above with reference to the module tool 350 which comprises the navigation menu.

The third column 340 comprises a tool 380 for changing the width of the third column 340 relative to the combined width of the first, second, and third columns; a module tool 385 comprising a user poll module; a module tool 390 comprising an advertising box module; and a button 355 for adding a module to the third column 340.

The user poll module and the advertising box module are prepared modules supplied by the Zlog production server 210 (FIG. 2). The module tools 385, 390 comprising the above-mentioned modules include drop down lists and remove links similar to the drop down list 352 and the remove link 353 described above with reference to the module tool 350 which comprises the navigation menu.

It is to be appreciated that when more than one module has been selected to be included in the column of the layout, tools 395 for changing the order of the modules in each column are displayed. By way of the above non-limiting example, tools 395 are displayed next to appropriate modules, enabling the Zlog producer 200 to move the location of the modules relative to other modules in the column.

The third part 315 of the user interface 300 comprises a text box 396 for naming the layout, a button 397 for saving the layout, and a button 398 for initiating a process of producing web pages.

The following is a description of modules prepared by the Zlog server 210 (FIG. 2) and available for selection by the Zlog producer 200 (FIG. 2).

The content module displays automatically-updating content. The source of the automatically-updating content is the Zlog server 210, the Zlog server filtering and aggregating the content from other content sources, and updating the content substantially often. When the Zlog server 210 updates content, the content is caused to update in browsers browsing the Zlog and viewing the content module.

By way of a non-limiting example, the Zlog server 210 comprises a database of 20,000 content feeds, the content feeds being manually picked and associated with content categories. All the content feeds are scanned, and content from the content feeds is saved in the Zlog server 210. The saved content is filtered, removing content irrelevant to the content category and removing content with irrelevant advertising, and the filtered content is saved in a database comprised in the Zlog server. Content from the database is used to rebuild, in other words refresh, content which users have picked, or will pick, to include in Zlogs. The content from the database is preferably built, and subsequently rebuilt, in XML format. The process of scanning, filtering, and rebuilding content described above is performed automatically, by the Zlog server 210, once an hour, to provide up-to-date content at any given time.

Persons skilled in the art will appreciate that scanning and saving is performed separately from filtering, and rebuilding is performed separately from filtering scanning and saving. Each of the above-mentioned steps is also split into a plurality of different tasks. Splitting the process of scanning, filtering, and rebuilding content into steps and tasks, and performing the tasks simultaneously, keeps process duration of the non-limiting example described above, of 20,000 content feeds, to approximately one hour.

A content ticker module displays automatically-updating content. The source of the automatically-updating content is the Zlog server 210, in similar fashion to the content module. The content ticker module is displayed differently at the browser: the content is displayed, at a browser, as a constantly scrolling ticker.

The content search module enables search of the automatically-updating content. The source of the automatically-updating content is the Zlog server 210, which aggregates the content from other content sources, and updates the content substantially often. The content search module searches the aggregated and updated content on the Zlog server 210, and displays the results of the search.

A blog module displays content, typically comprising text and images. The source of the content comprised in the blog module is content entered by the Zlog producer 200. The blog module displays the content in a format of a web-log (blog), as is well known in the art.

A news blog module displays automatically-updating content and comments. The comments may be written by readers of the news blog module, and are directed to the automatically-updating content. The source of the automatically-updating content comprised in the news blog module is similar to the source of the automatically-updating content in the content module. The news blog module displays the content in a format of a web-log (blog), as is well known in the art

The user poll module displays content, the content being a question put to the readers of the user poll module via the Zlog, and to display statistics of readers' answers to the question. The source of the question comprised in the user poll module may be content entered by the Zlog producer 200, and the source of the statistics of readers' answers to the question is based at least in part on computation performed by the Zlog server 210.

A survey module displays content, the content being more than one question put to the readers of the survey module via the Zlog, and displays statistics of readers' answers to the questions. The source of the questions comprised in the survey module may be content entered by the Zlog producer 200, and the source of the statistics of readers' answers to the plurality of questions may be based at least in part on computation performed by the Zlog server 210.

A forum module displays content, typically comprising text. The source of the content comprised in the forum module (not shown) is content entered by the readers of the Zlog.

The advertising box module displays at least one advertisement, typically comprising at least one of text, images, and links to a web site maintained by an advertiser. The source of the content comprised in the advertising box module may be content entered by the Zlog producer 200, typically being content provided by the advertiser.

The navigation menu module displays links to web pages comprised in the Zlog, and to other web sites. The links comprised in the navigation menu module may be defined by the Zlog producer 200.

The HTML area module displays content, the content comprising any content provided in HTML format. The source of the content comprised in the HTML area module may be content entered by the Zlog producer 200.

An image area module displays one or more images, the images comprising any image content provided in popular digital image formats, such as, and without limiting the generality of the foregoing, .bmp, .jpg, .tiff, .png, .gif, and so on. The source of the images comprised in the image area module may be images entered by the Zlog producer 200. The Zlog production server 210 preferably provides a library of digital images for the Zlog producer 200 to include in the image area module.

A program module runs within a web browser. The program module preferably comprises a program written in a web programming language such as, by way of a non-limiting example, flash, java, JavaScript, VBscript, and so on. The program module is preferably uploaded to the Zlog production server 210 by the Zlog producer 200. The program module is preferably compatible with Web 2.0 technology.

In one preferred embodiment of the present invention the Zlog production server 210 provides a set of online tools, comprising an API, to be used by the Zlog producer 200 to produce the program module.

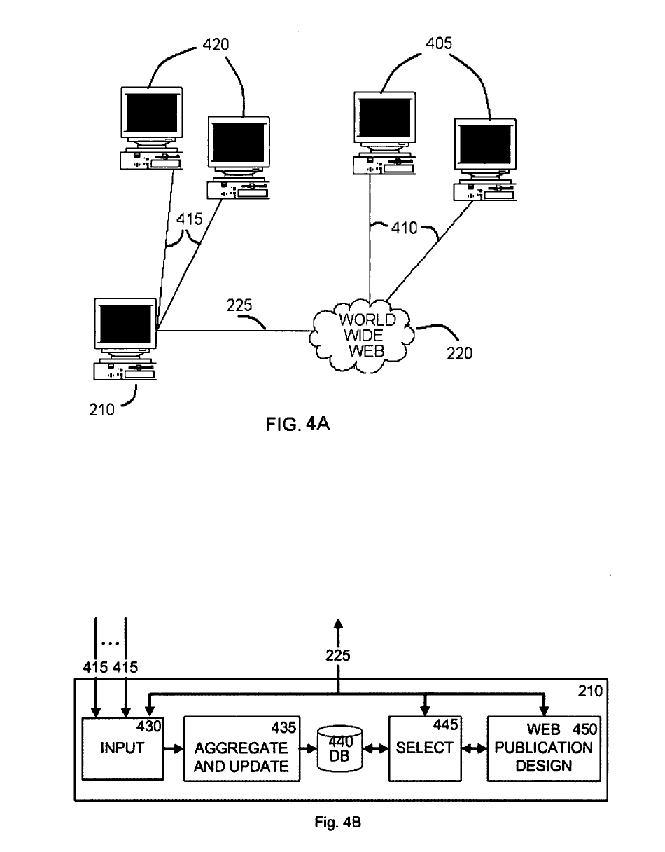

Reference is now made to FIG. 4A, which is a simplified illustration of content sources associated with aggregation of content and automatic updating in accordance with the system of FIG. 1.

The Zlog server 210 (also of FIG. 2) is preferably connected via the WWW connection 225 (also of FIG. 2) to the WWW 220. Various content sources 405 are available on the WWW 220 and connected to the WWW via connections 410, thereby being also connected to the Zlog server 210. The Zlog server 210 is also preferably connected via one or more direct connections 415 to one or more additional content sources 420.

The Zlog server 210 aggregates content provided by the content sources 405, 420. The aggregated content is updated substantially often, as described above with reference to FIG. 3, using technology appropriate to each content source 405, 420.

Persons skilled in the art will appreciate that content updating is done using various “push” and “pull” technologies. One content updating technology, by way of a non-limiting example, is RSS (Really Simple Syndication, or Rich Site Summary, or RDF Site Summary).

Having the Zlog server 210 perform content aggregation and content updating provides an element of technological simplification for the Zlog producer 200 (FIG. 2) of the system of FIG. 1.

Reference is now made to FIG. 4B, which is a simplified block diagram illustration of input, aggregation, automatic updating, and selection of content from content sources in accordance with the system of FIG. 1.

FIG. 4B depicts the Zlog server 210 of FIG. 4A, the one or more direct connections 415 between the Zlog server 210 and one or more additional content sources (not shown), and the WWW connection 225 of the Zlog server 210.

The connections 415 225 of the Zlog server 210 enable the Zlog server to input continuously updated content using suitable technology, as described above with reference to FIG. 4A. The input is preferably performed by an input unit 430 through the connections 415 225.

The input unit 430 is connected to an aggregation and update unit 435, which receives the content from the input unit 430, filters, aggregates, and updates a store of content in a database 440. The process of input, filtering, aggregation and update was also described above with reference to FIG. 3.

In order to produce a Zlog, the Zlog producer 200 accesses a selection unit 445 comprised in the Zlog server 210, through the WWW connection 225, and selects continuously updated content stored on the database 440.

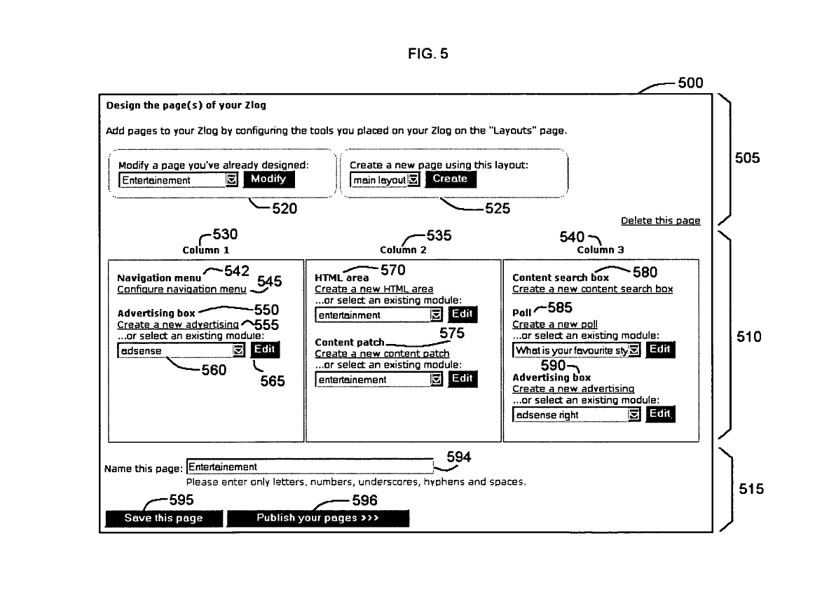

In a preferred embodiment of the present invention, the Zlog producer 200 accesses a web publication design unit 450 comprised in the Zlog server 210. The web publication design unit 450 enables the Zlog producer 200 to select modules from a list of modules available on the Zlog server 210, for adding to the Zlog being produced. The module selection was described above, with reference to FIG. 3, and will be additionally described below, with reference to FIG. 5. The web publication design unit 450 is connected to the selection unit 445, enabling both a selection of continuously updated modules from the database 440, as well as saving Zlog designs produced by the Zlog producer 200.

Reference is now made to FIG. 5 which is a simplified illustration of a user interface 500 for producing a web page in accordance with the system of FIG. 1. The user interface 500 of FIG. 5 is brought herein by way of a non-limiting example, in order to demonstrate a preferred functionality. It is to be understood that the phraseology and terminology employed in the user interface of FIG. 5 is for the purpose of description and should not be regarded as limiting.

The user interface 500 is comprised of three parts. The three parts of the user interface 500 are: a first part 505 for producing a new web page or selecting an existing web page to modify; a second part 510 for editing the web page; and a third part 515 for naming the new web page, saving the new web page, and initiating publication of the Zlog.

The first part 505 of the user interface 500 comprises a first tool 520 for producing a new web page by selecting and modifying a web page which the Zlog producer 200 (FIG. 2) has previously produced, and a second tool 525 for producing a new web page by selecting a layout from among layouts which the Zlog producer 200 has produced and saved on the Zlog server 210 (FIG. 2), and additional prepared layouts which the Zlog server makes available to all users of the system of FIG. 1.

It is to be appreciated that the second part 510 of the user interface 500 and the third part 515 of the user interface 500 are displayed only after the Zlog producer 200 has made a selection using tools of the first part 505 of the user interface 500.

The second part 510 of the user interface 500 comprises tools for editing the new web page. The second part 510 displays a schematic interactive representation of the new web page produced by the Zlog producer 200, showing components comprised in the web page. By way of a non-limiting example, the new web page was produced by selecting a layout comprising a first column 530, a second column 535, and a third column 540.

The first column 530 comprises, by way of a non-limiting example, a navigation menu module 542, and an advertising box 550. A link 545 to a tool for configuring the navigation menu module 542, a link 555 to a tool for configuring the advertising box 550, and a drop-down list 560 for selecting a configuration for the advertising box 550 from among existing advertising modules are also provided.

One configuration tool is preferably a navigation menu configuration tool. The link 545 to the tool for configuring the navigation menu module 542 provides the Zlog producer 200 (of FIG. 2) access to the navigation menu configuration tool, for using to configure the navigation menu module 542.

Two configuration tools are available for configuring the advertising box 550. A first configuration tool for configuring a new advertising box is provided through the link 555. A second configuration tool is provided by using the drop-down list 560 to select from existing advertising modules, and using an edit button 565 to provide the second configuration tool for configuring the existing advertising module.

It is to be appreciated that configuration tools similar to the link 555, the drop-down list 560 for selecting from existing advertising modules, and the edit button 565, are associated with other modules on the web page, in order to enable the Zlog producer 200 to configure the other modules on the web page.

The second column 535 comprises, by way of a non-limiting example, an HTML area module 570, and a content module 575.

The HTML area module 570 and the content module 575 comprise links to configuration tools, drop down lists, and edit buttons similar to the configuration link 555, the drop down list 560, and the edit button 565 described above with reference to the advertising box 550.

The third column 540 comprises, by way of a non-limiting example, a content search module 580, a user poll module 585, and an advertising box module 590.

The content search module 580 comprises a link to a content search configuration tool, similar to the link 545 described above with reference to the navigation menu module 542.

The user poll module 585, and the advertising box module 590 comprise links to configuration tools, drop down lists, and edit buttons similar to the configuration link 555, the drop down list 560, and the edit button 565 described above with reference to the advertising box 550.

The third part 515 of the user interface 500 comprises a text box 594 for naming the web page; a button 595 for saving the web page; and a button 596 for publishing the Zlog.

Reference is now made to FIG. 6 which is a simplified illustration of a user interface 600 for adding custom data associated with the online magazine, saving, pre-viewing, and publishing the online magazine, in accordance with the system of FIG. 1.

The user interface 600 of FIG. 6 is brought herein by way of a non-limiting example, in order to demonstrate a preferred functionality. It is to be understood that the phraseology and terminology employed in the user interface of FIG. 6 is for the purpose of description and should not be regarded as limiting.

The user interface 600 comprises:

a first tool 610 for entering a title for the Zlog. The title typically comprises a short text description of the Zlog. Persons skilled in the art will appreciate that WWW search engines generally assign different importance to words in the title than to words in the pages comprising the Zlog;

a second tool 615 for entering a description of the Zlog. The description typically comprises a second text description of the Zlog, often longer than the title of the Zlog. Persons skilled in the art will appreciate that WWW search engines generally treat words in the description differently than words in the pages comprising the Zlog;

a third tool 620 for entering keywords associated with the Zlog. The keywords typically comprise a set of words generally associated with the subject of the Zlog, not disposed together as a grammatical sentence. Persons skilled in the art will appreciate that WWW search engines generally treat keywords differently than words in the pages comprising the Zlog;

a fourth tool 625 for entering text to be displayed in a header which is displayed at the top of substantially every page of the Zlog. A typical use for the header can be to inform readers about copyright of material in the Zlog, to inform readers about the Zlog producer 200 (FIG. 2), to inform readers how to contact the Zlog producer 200, and so on;

a fifth tool 630 for entering text to be displayed in a footer which is displayed at the bottom of substantially every page of the Zlog. Footers are typically used for the same purposes as headers. Generally, text which the Zlog producer 200 desires to appear on every page is apportioned between the header and the footer. Persons skilled in the art will appreciate that the footer may require scrolling down in order to be visible to the reader, while the header is visible on first opening the page;

a sixth tool 635 for selecting a category which best describes a main purpose of the Zlog, according to the Zlog producer 200. The selection of the category is made from a drop down list of prepared categories which are provided in the system of FIG. 1;

a seventh tool 640 for selecting a homepage for the Zlog. The selection of the homepage is made from a drop down list of the web pages comprising the Zlog. It is appreciated by persons skilled in the art that the homepage is usually a first page which a reader of the Zlog reads, and is selected by the Zlog producer 200 to be the first page; and

an eighth tool 645 for saving, publishing, and viewing the Zlog.

In one preferred embodiment of the present invention, the eighth tool 645 is a user interface button, which, upon the Zlog producer 200 clicking the button, causes the following to occur:

in a first step, the data entered in the user interface 600 is saved in the system of FIG. 1;

in a second step, the Zlog is published, which means that the Zlog is made available to persons browsing the WWW; and

in a third step, the Zlog is displayed in the web browser of the Zlog producer 200.

In other alternative preferred embodiments of the present invention, the above mentioned three steps are performed in a different order.

In yet other alternative preferred embodiments of the present invention, the functionality of the above mentioned three steps is apportioned among two user interface tools, preferably buttons, and among three user interface tools, preferably buttons.

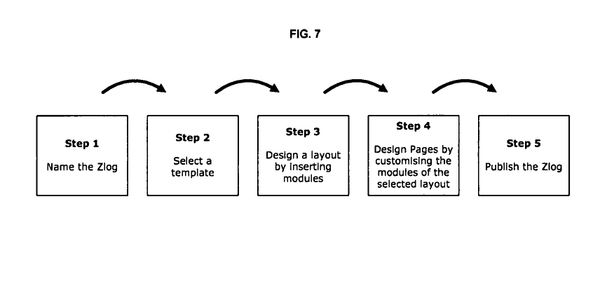

Reference is now made to FIG. 7, which is another simplified flow chart illustration of a preferred method of operation of the system of FIG. 1. The method of FIG. 7 is self-explanatory in light of the above discussion of FIGS. 1, 2, 3, 5, and 6.

It is expected that during the life of this patent many relevant devices and systems will be developed and the scope of the terms herein, particularly of the terms World Wide Web, WWW, web, online; online magazine; Zlog; RSS, layout, and news ticker, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A computer system for supporting inclusion of continuously updated content into web publications, the computer system comprising:
an input unit for obtaining content from a plurality of sources of continuously updatable content at independent locations over a network; and
a selection unit for representing the plurality of sources to a user, allowing the user to select from the plurality of sources using the selection unit, thereby building content from the selected sources into a web publication produced online by the user.

2. The computer system according to claim 1 and further comprising a database for storing the content obtained from the plurality of sources.

3. The computer system according to claim 1 and wherein the plurality of sources comprises a plurality of RSS (Really Simple Syndication) content feeds.

4. The computer system according to claim 1 and wherein the computer system is operative to enable the user to include a search interface in the web publication, the search interface operatively associated with the content in the web publication.

5. The computer system according to claim 1 and wherein the computer system further comprises a web page design unit enabling the user to select web publication modules to add to the web publication from a selection of web publication modules provided by the computer system.

6. The computer system according to claim 5 and wherein some of the web publication modules in the selection of web publication modules provided by the computer system are operatively associated with the content from the selected sources.

7. The computer system according to claim 6 and wherein the selection of web publication modules comprises a search module comprising:
a search interface operative to accept a search definition;
a search routine operative to transmit the search definition to the computer system; and
a search result routine operative to accept search results from the computer system and display the search results.

8. The computer system according to claim 6 and wherein the selection of web publication modules comprises a ticker module operative to display the content in the ticker module formatted as a news ticker.

9. The computer system according to claim 5 and wherein the web page design unit is operative to enable the user to select a layout for the web publication from a selection of web publication layouts provided by the computer system, and use the layout to design the web publication based, at least in part, on the selected layout.

10. The computer system according to claim 9 and wherein the web page design unit is operative to enable the user to modify the selected layout.

11. The computer system according to claim 9 and wherein the web page design unit is operative to enable the user to select more than one layout and to design the web page publication based on the selected layouts.

12. The computer system according to claim 5 and wherein the selection of web publication modules comprises a blog module operative to display the content in the web publication formatted as a web log.

13. The computer system according to claim 5 and wherein the computer system enables the user to add a module to the selection of web publication modules, thereby producing a modified selection of web publication modules, and to select the added module from the modified selection of web publication modules, thereby causing the added module to be added to the web publication.

14. The computer system according to claim 5 and wherein the selection of web publication modules comprises an advertising module, the advertising module comprising advertising selected by the user using the selection unit to select advertising from the plurality of sources.

15. The computer system according to claim 5 and wherein the selection of web publication modules comprises a navigation module, the navigation module providing a navigation menu comprising at least one link to at least one web page comprised in the web publication.

16. A computer system for producing an automatically-updating online magazine, the online magazine comprising at least one World Wide Web (web) page, the computer system providing an online user with an interface for:
naming the online magazine;
designing a layout of the online magazine, the designing a layout comprising:
producing at least one layout, the producing at least one layout comprising:
selecting at least one layout template from a list of layout templates;
selecting at least one module from a list of modules, the module to be comprised in the at least one produced layout; and
naming the at least one layout, thereby producing the at least one layout;
producing at least one web page, the producing at least one web page comprising:
selecting at least one layout from the at least one layout produced; and
naming the at least one web page, thereby producing at least one web page;
selecting a home page from the at least one web page;
adding custom data to be associated with the online magazine; and
publishing the online magazine,
wherein the at least one module comprises content aggregated substantially frequently from a plurality of content feeds and the publishing makes the online magazine available to users of the web.

17. The computer system according to claim 16 and wherein the plurality of content feeds comprises a plurality of content feeds from a plurality of different web sites.

18. The computer system according to claim 16 and wherein the plurality of sources comprises a plurality of RSS (Really Simple Syndication) content feeds.

19. The online method of claim 16 and wherein the at least one module comprises a search interface operatively associated with the content.

20. A World Wide Web (web) server, the web server operative to communicate with users via the web, the web server operative to produce a web site comprising an online magazine, the online magazine comprising:
a name associated with the online magazine;
a layout comprising:
at least one web page, produced by selecting at least one template from a list of web page templates;
at least one module to be comprised in the at least one web page, the at least one module selected from a list of modules, the at least one module comprising content aggregated substantially frequently from a plurality of content feeds; and
a name associated with the at least one web page;
a home web page selected from the at least one web page; and
custom data associated with the online magazine,
and wherein the web server is operative to publish the web site comprising the online magazine, making the web site comprising the online magazine available to users of the web.

21. A computer-readable storage medium containing a set of instructions for a general purpose computer having a user interface comprising a web browser on the World Wide Web (web), the set of instructions comprising:
a) an input routine operatively associated with said user interface for producing an automatically-updating online magazine, the online magazine comprising at least one web page, the producing an automatically-updating online magazine comprising:
naming the online magazine;
designing a layout of the online magazine, the designing a layout comprising:
producing at least one layout, the producing at least one layout comprising:
selecting at least one layout template from a list of layout templates;
selecting at least one module from a list of modules, the module to be comprised in the at least one produced layout; and
naming the at least one layout, thereby producing the at least one layout;
producing at least one web page, the producing at least one web page comprising:
selecting at least one layout from the at least one layout produced; and
naming the at least one web page, thereby producing at least one web page;
selecting a home page from the at least one web page;
adding custom data to be associated with the online magazine; and
publishing the online magazine,
wherein the at least one module comprises content aggregated substantially frequently from a plurality of content feeds and the publishing makes the online magazine available to users of the web, and
b) a run routine for implementing said producing an automatically-updating online magazine.

22. A computer-readable storage medium containing a set of instructions for a general purpose computer having a user interface comprising a web browser on the World Wide Web (web), the set of instructions comprising:
an input routine for obtaining content from a plurality of sources of continuously updatable content at independent locations over a network;
a run routine for implementing the obtaining content from a plurality of sources;
a selection routine for representing the plurality of sources to a user, allowing the user to select from the plurality of sources using the selection unit, thereby building content from the selected sources into a web publication produced online by the user; and
a run routine for implementing the representing the plurality of sources to a user.

23. A method for supporting inclusion of continuously updated content into web publications, the method comprising:
obtaining content from a plurality of sources of continuously updatable content at independent locations over a network; and
representing the plurality of sources to a user, allowing the user to select from the plurality of sources, thereby building content from the selected sources into a web publication produced online by the user.

24. An online method for producing an automatically-updating online magazine, the online magazine comprising at least one World Wide Web (web) page, the online method comprising:
naming the online magazine;
designing a layout of the online magazine, the designing a layout comprising:
producing at least one layout, the producing at least one layout comprising:
selecting at least one layout template from a list of layout templates;
selecting at least one module from a list of modules, the module to be comprised in the at least one produced layout; and
naming the at least one layout, thereby producing the at least one layout;
producing at least one web page, the producing at least one web page comprising:
selecting at least one layout from the at least one layout produced; and
naming the at least one web page, thereby producing at least one web page;
selecting a home page from the at least one web page;
adding custom data to be associated with the online magazine; and
publishing the online magazine,
wherein the at least one module comprises content aggregated substantially frequently from a plurality of content feeds and the publishing makes the online magazine available to users of the web.
